(19) United States
(12) Patent Application Publication
(10) Pub. No.: US 2002/0168234 A1
(43) Pub. Date: Nov. 14, 2002

(54) Erosion control system and methods

(76) Inventor: George D. Hild, Stillwater, MN (US)

Correspondence Address: SKINNER & ASSOCIATES, 619 SECOND STREET, SUITE 201, HUDSON, WI, 54016, US

(21) Appl. No.: 10/090,890

(22) Filed: Mar. 4, 2002

Related U.S. Application Data
(60) Provisional application No. 60/273,019, filed on Mar. 2, 2001.

(51) Int. Cl. E02D 17/20; C09K 17/00; E02B 3/04

(52) U.S. Cl. 405/302.4; 405/302.6; 405/302.7; 405/15

(57) ABSTRACT

An erosion control blanket comprises a layer of sand, a layer of polyethylene, a blanket layer, a soil-less mixture layer, and a seed mixture. The components are disposed in a blanket of a predetermined configuration, and rolled or folded. A method of making the blanket comprises the steps of constructing a frame, adding a layer of sand inside the frame, adding a layer of polyethylene over the sand layer, adding a blanket layer over the polyethylene, adding a layer of soil-less mixture over the blanket layer, adding a seed mixture to the soil-less mixture, aging the components, and harvesting the aged components. The step of aging preferably includes the steps of adding fertilizer, adding a water retention substance, and watering the components. Preferably, a poly film covers the frame. The step of harvesting preferably includes the steps of cutting the aged components into a predetermined configuration, and rolling or folding the cut components.

### CROSS-REFERENCE TO RELATED APPLICATIONS, IF ANY

This application claims the benefit under 35 U.S.C. §119(e) of co-pending U.S. Provisional Patent Application Serial No. 60/273,019, filed Mar. 2, 2001, which is hereby incorporated by reference.

### 37 C.F.R. §1.71(e) AUTHORIZATION

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### STATEMENT REGARDING FEDERALLY SPONSORED RESEARCH OR DEVELOPMENT

Not applicable.

### REFERENCE TO A MICROFICHE APPENDIX, IF ANY

Not applicable.

### BACKGROUND OF THE INVENTION

1. Field of the Invention

The present invention relates, generally, to soil stabilization and erosion control products, systems and methods. More particularly, the invention relates to prevegetated or preplanted erosion control products (blankets and patches), methods of making such blankets, and methods of employing such blankets.

2. Background Information

A need exists for soil stabilization for the purpose of controlling erosion as well as establishing a method of rapid establishment of long term native and non-native plant material species. Needs also exist in the area of restoration of difficult sites such as steep slopes, shorelines, ditch bottoms, as well as all other sites vulnerable to erosion and soil degradation will benefit from the use of this technology. Erosion control and site restoration activities are conduced by business, government agencies, engineering firms, as well as the private sector.

Existing technology is believed to have significant limitations and shortcomings. Existing technology includes U.S. Pat. No. 5,555,674 to Molnar et al., and U.S. Pat. No. 5,344,470 to Molnar et al.

The present invention provides an erosion control blanket article or product, system, a method of making such article and system, and a method of employing such article and system, which are believed to constitute an improvement over prior art. Erosion control and restoration efforts are important in difficult areas such as those vulnerable to shoreline wave action, steep slope and ditch bottom runoff, and stream edges experienced failures of seed and plant materials due to environmental conditions such as animal plant predation, wave action, shear or slope stresses, and highly erodible soils that experience frequent runoff or ice.

The invention significantly improves the success rate of erosion/restoration efforts by providing a product and method to introduce and hold vegetation in place, ensuring rapid establishment of the vegetative components resulting in quickly stabilized soils.

This invention significantly improves the user/applicators success by eliminating seed loss due to animal activities and various environmental conditions. Eliminating the high risk factors which result in erosion control and restoration failures is the purpose and goal of this invention.

All US patents and patent applications, and all other published documents mentioned anywhere in this application are incorporated by reference in their entirety.

### BRIEF SUMMARY OF THE INVENTION

The present invention provides a prevegetated or preplanted erosion control blanket or patch, method of making such blanket or patch, and method of employing such blanket or patch.

The erosion control blanket/patch of the invention comprises a layer of sand, a layer of polyethylene, a blanket layer, a soil-less mixture layer, and a seed mixture. The components are disposed in a blanket (relatively large) or patch (relatively small) of a predetermined configuration, and rolled or folded.

The method of making the blanket comprises the steps of constructing a frame in the case of a blanket or tray in the case of a patch, adding a layer of sand inside the frame, adding a layer of polyethylene over the sand layer, adding a blanket layer over the polyethylene, adding a layer of soil-less mixture over the blanket layer, adding a seed mixture to the soil-less mixture, aging the components, and harvesting the aged components. The step of aging preferably includes the steps of adding fertilizer, adding a water retention substance, and watering the components. Preferably, a poly film covers the frame. The step of harvesting preferably includes the steps of cutting the aged components into a predetermined configuration, and rolling or folding the cut components.

The invention may be used by the department of transportation, the erosion control industry, real estate developers, soil and water conservation districts, park and recreation boards, towns and municipalities, watershed districts, restorationists, the department of natural resources, as well as any person or entity involved in erosion control and restoration projects of all types.

The features, benefits and objects of this invention will become clear to those skilled in the art by reference to the following description, claims, and drawings.

### BRIEF DESCRIPTION OF THE SEVERAL VIEWS OF THE DRAWING

FIGS. 1-3 illustrate the erosion control blanket/patch of the present invention, and wherein

FIG. 1 illustrates typical development at 2 weeks from seeding,

FIG. 2 illustrates typical development at 6 weeks, and

FIG. 3 illustrates a completed blanket.

FIGS. 4-11 illustrate steps of the method of making the erosion control blanket of the invention, and wherein:

FIG. 4 shows a patch tray being filled with material.

FIG. 5 shows framed blanket material including a coconut fiber blanket covered with soil-less mixture and seed mixture with poly film not yet covering the top.

FIG. 6 shows plant growth, and poly film temporarily removed for clarity.

FIG. 7 shows substantially the same view as FIG. 7.

FIG. 8 shows coconut fiber being cut for placement in a patch tray.

FIG. 9 shows similar material as FIG. 8.

FIG. 10 shows completed patch trays.

FIG. 11 shows adding soil-less mixture and seed mixture to a patch tray.

FIGS. 12-19 illustrate steps of the method of using the erosion control blanket of the invention, wherein FIG. 12 shows a flat layer of blanket being removed from a multi-layered transportation bed of a vehicle; FIG. 13 shows the layer of FIG. 13 being removed from the vehicle bed; and FIGS. 14-19 show layers being moved into position and in being established at the intended location.

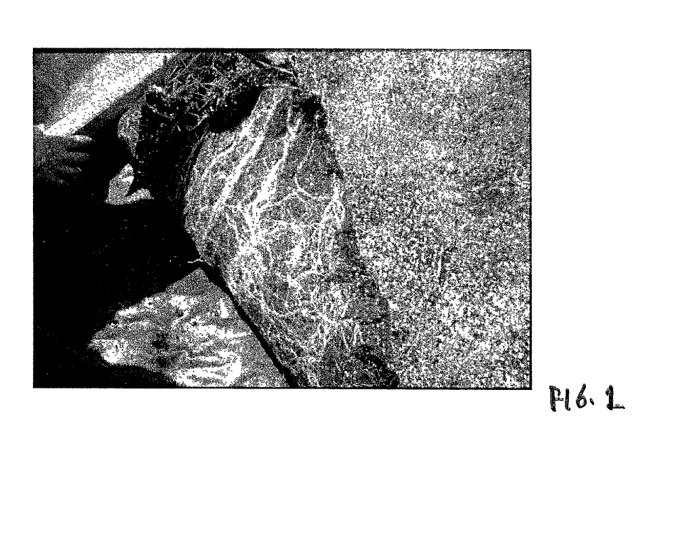

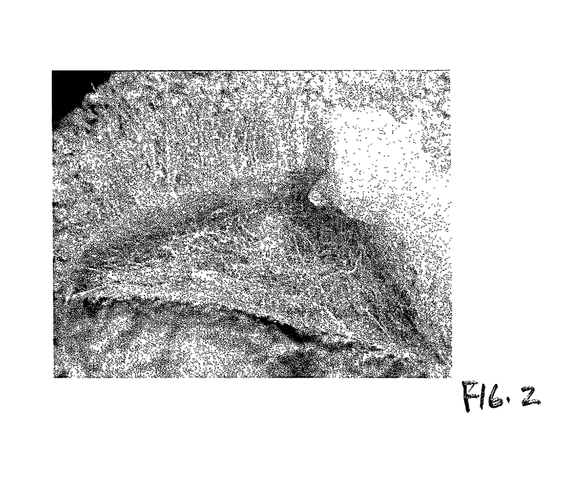

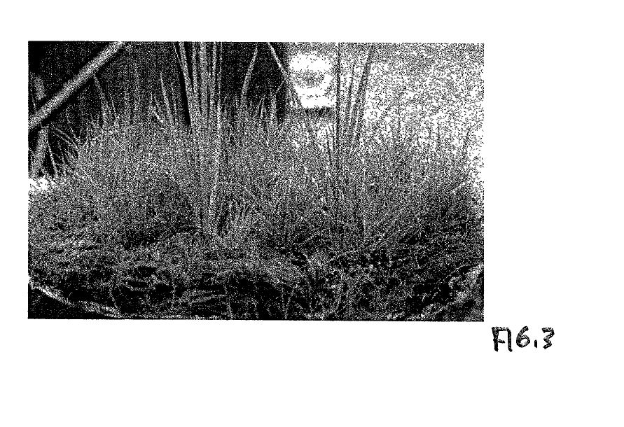

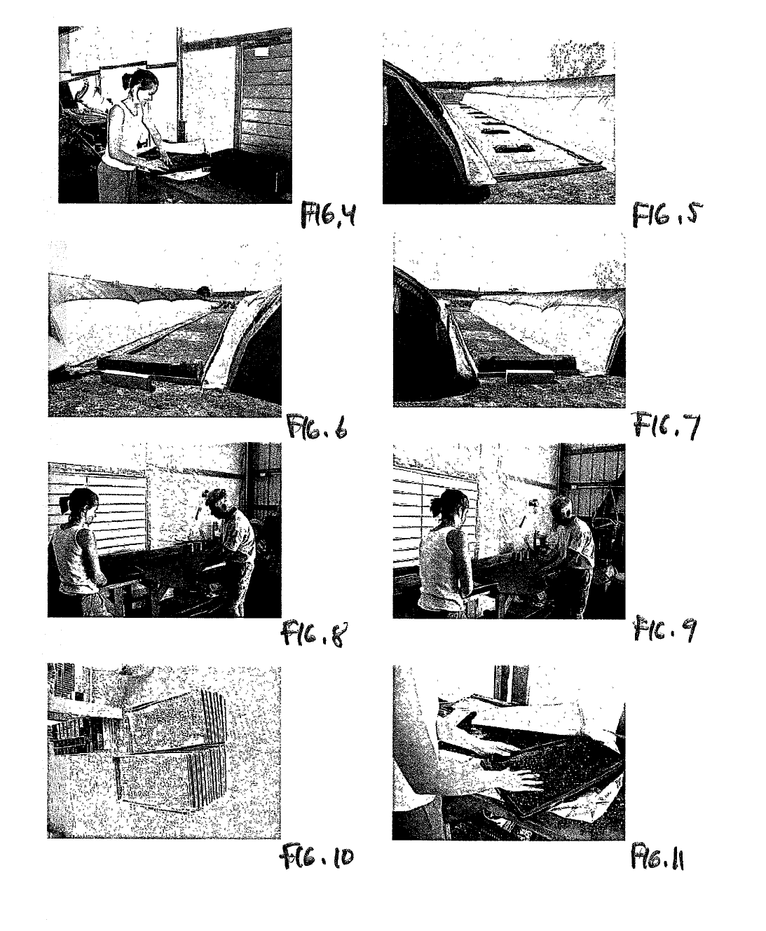

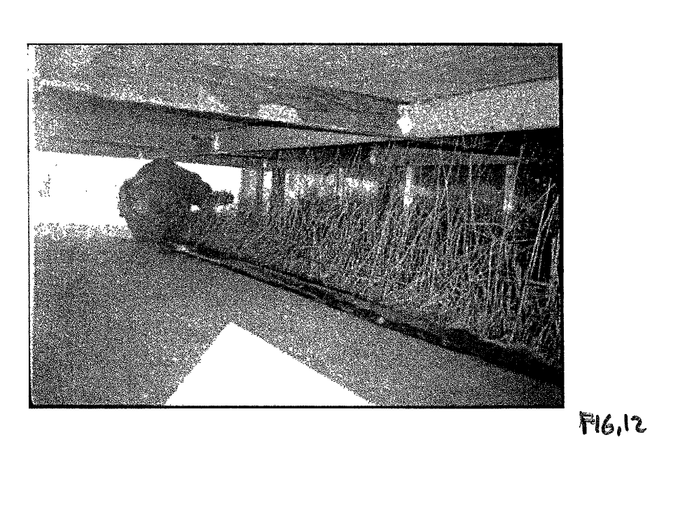

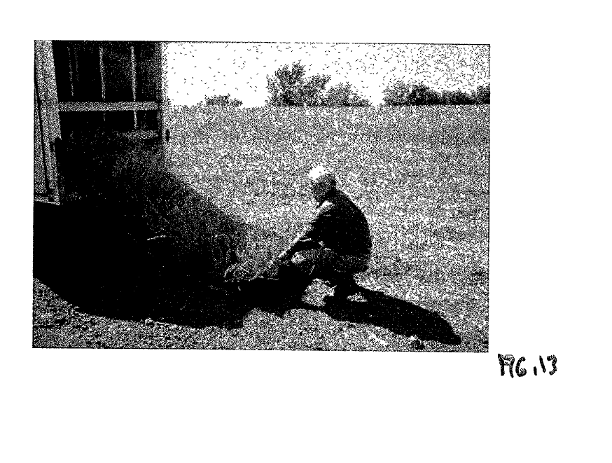

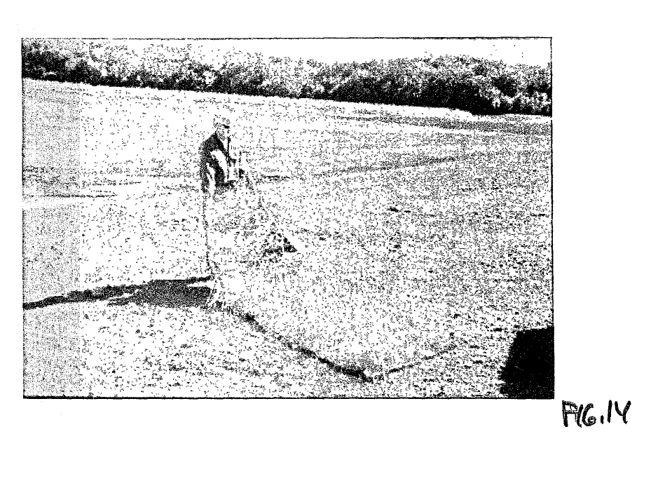

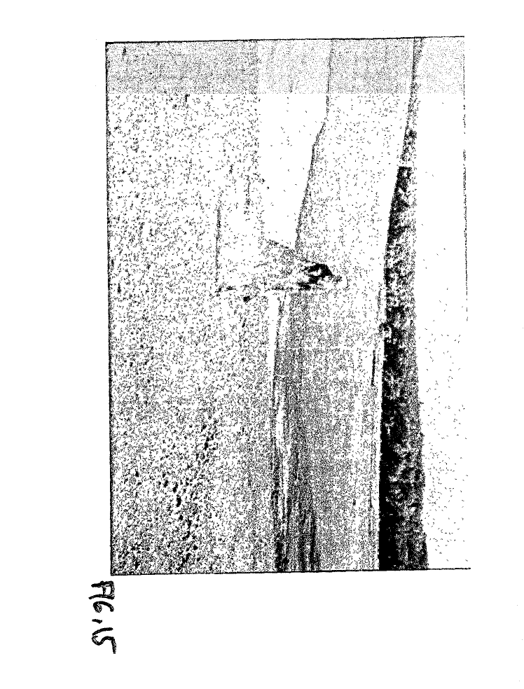

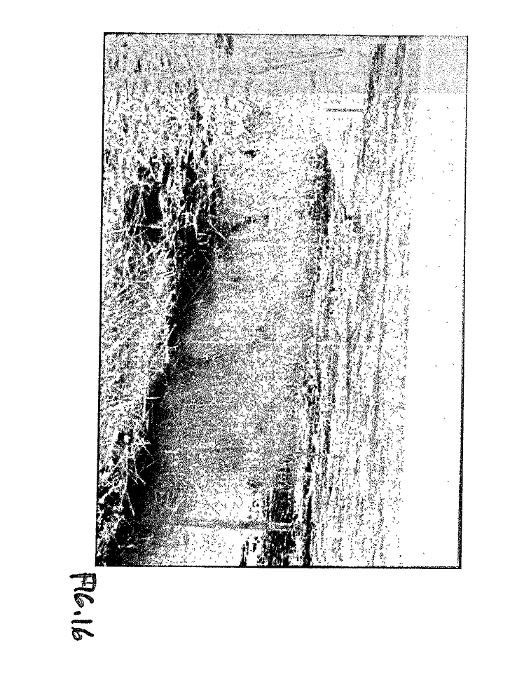

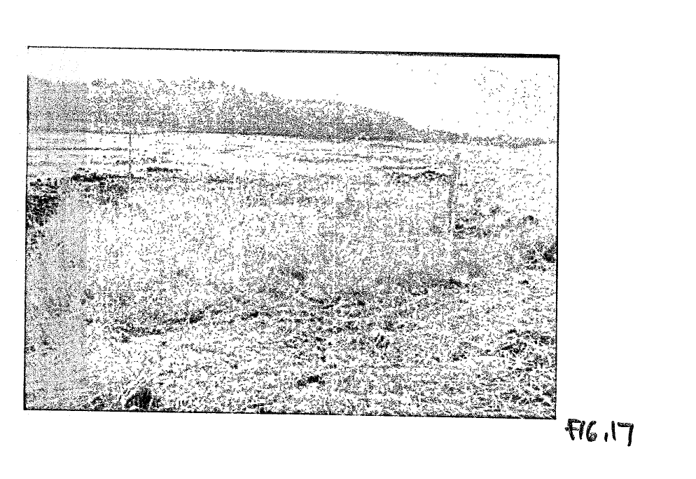

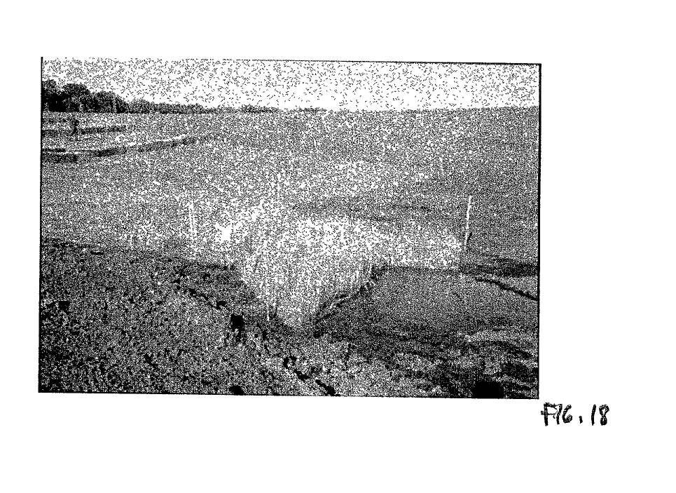

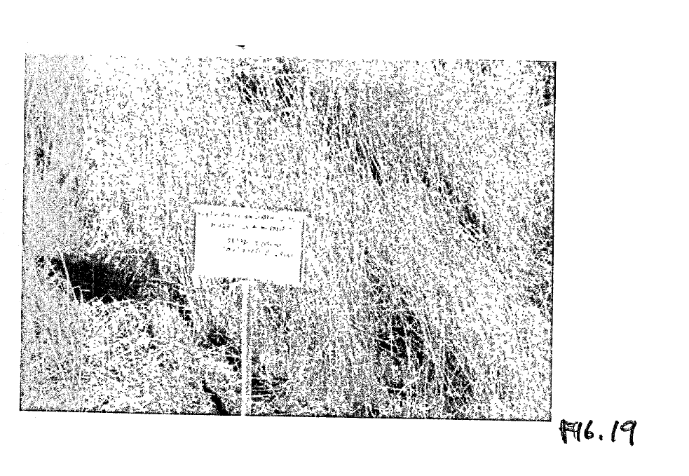

### DETAILED DESCRIPTION

1. Overview of the Technology

The erosion control blanket or patch of the invention comprises a layer of sand, a layer of polyethylene, a blanket layer, a soil-less mixture layer, and a seed mixture. The components are disposed in a blanket of a predetermined configuration, and rolled or folded.

The erosion control blanket or patch of the present invention is produced under specific conditions with specific components designed in response to and applied to specific site environmental conditions such as soil types, moisture levels, and desired long term vegetation.

The production process begins with a level or nearly level area of a size ranging from one square yard minimum to a maximum exceeding one acre or more. A frame is constructed using two by four, or two by six treated dimensional lumber or a product equal in purpose. For patches, a sealed bottom, waterproof tray is used. A two by four or item equal in purpose is installed to provide side wall strength and to maintain straightness. The finished dimensional lumber frame usually is constructed to achieve a completed measurement of 6.5′ wide by 100′ long. The base of the inside of the frame is covered with 1.5″ of sand to remove level irregularities and provide for proper drainage.

One layer of a commercial grade 6 mil in thickness black polyethylene is rolled out to cover the sand layer. This plastic layer provides for a root zone development and management area by maintaining moisture at acceptable levels for vegetation establishment, prevents contamination from non desirable weedy species, and allows for moisture retention during harvesting and shipping.

At this point, an appropriate erosion control blanket is selected for use based on the demands and requirements for the final product and its desired results, preferably a pre manufactured erosion control blanket ranging from 100% biodegradable coconut blanket or a three dimensional matrix of synthetic material that may also consist partially of biodegradable materials. A layer of a weed free soil-less mixture used in commercial greenhouse production but without floatable components like Perlite is supplied. Preferred mixtures include PRO-MIX ‘PGX’ manufactured by Premier Horticulture USA. This layer varies in thickness from a minimum of ¼ inch to as much as 1 inch or greater. The soil-less mix is distributed evenly over the entire erosion blanket.

A seed mixture is chosen for use again depending on site conditions and erosion blanket type. Seeding rates are generally 5-30 lbs/acre. The seed mixture is important. Only true native species consisting of a wide variety of combinations are used. These species consist of prairie grasses and prairie flowers, wetland and emergent species, established from both seed and from root cuttings. Prairie grasses and flowers are used not only because they are true native species but because of their extensive root structure which can reach depths of six feet into the soil. This excellent rooting capacity gives the erosion control blanket its superior rooting capacity and its long lived characteristic. In addition, a large number of the species used in the product are rhizomotous in nature (spread by roots) which adds additional bonding strength and increases the plant populations. Also the addition of a rapid germinating species, or cover crop, (annual rye grass) is added to aid development.

The seed mixes are certifiable through the Crop Improvement Association and generally referred to as Yellow Tag Seed. The erosion control blanket product preferably consists of a diverse cross rooted assemblage of clump prairie grasses and prairie flowers with at least but not limited to 50% cover with a minimum of three inches in cover crop plant height. erosion control blanket will also include wetland species.

The seed and/or plant components are fertilized with a sulfur coated slow release fertilizer such as Osmocote or a similar product intended to release nutrients to the seedlings slowly and over an extended period of time.

A water retention gel such as Hydretain® from Ecologel USA is then applied in a diluted liquid form. This biodegradable liquid improves seed germination and seedling survival, slows evaporation of applied waterings, minimizes localized dry spots, and aids in the product performance and establishment during the transportation and field installation of the product.

The erosion control blanket product is watered as required by either manual application or automatic application with or without a timer mechanism.

Once the erosion control blanket product is properly prepared and seeded, the dimensional frame is covered with either a clear or white greenhouse poly film. This application of covering film retains heat during the evening hours and during days where the temperature falls below acceptable growing levels (70 degrees daytime and 55 degrees evening). This covering is considered temporary and can be applied or removed at any time. This covering also is intended to provide protection early in the germination stage so the impact of heavy rains or animal activity is minimized.

The erosion control blanket is produced outside or in a greenhouse or similar structure 365 days per year.

Harvesting and delivery of erosion control blanket is accomplished by cutting the product to the desired square yard quantity with a knife or similar object. The 6 mil black poly beneath the erosion control blanket is also cut. The product and the poly are rolled or folded together to retain moisture during shipping and to add additional product handling strength and avoid product separation.

Specific application techniques and recommendations are shown in MNDOT spec 0, 01, 02, 03, 04, and the Section Staples, Pins in the Appendix.

Once the native species in the erosion control blanket become established on site these species begin to produce seed. This seed production produces a valuable indirect benefit by supplying a seed source for the establishment of additional desirable plants.

The erosion control and restoration industry would typically experience failures when attempting to deal with sites that presented special challenges. The industry needed a product that would meet those challenges. The erosion control blanket successfully eliminates the high risk of failure factor that these special site conditions presented to the industry. The rapid establishment of prevegetated prairie and wetland species with a nurse or cover crop significantly reduces the high risk period that conventional seeding methods were unable to provide.

Other approaches searched for the fastest germination rate species to establish a quick cover crop thereby reducing the critical period between seeding and establishment strong enough to hold the soils. This method is the most widely used method and will continue in that capacity. However, the erosion control blanket product will be able to address and solve the most difficult sites and applications where standard methods have failed.

2. Alternative Embodiments

The erosion control blanket is produced in different versions based on the selection of two main components. Firstly, the seeding mixture can be changed in terms of seeding rate, percentages of each species used, variable site conditions such as wet, mesic, or dry soils, and light availability such as sun or shade. An example of a seed mixture that is used in blanket production for use by the Minnesota Department of Transportation is the 28A mix (see attachment). In addition to seed mixture changes, plants that are difficult to establish from seed can be inserted manually into the blanket using rootstock or cuttings from existing material. Plugging of rootstock, cuttings, or bulbs and tubers can vary from 0% to 100% of the blanket area.

Secondly, the blanket type and structure can be changed to accommodate site conditions and product longevity expectations. Blanket longevity expectations range from 100% biodegradable to permanent. Blanket types are classified and selected according to these specifications. Commercially produced erosion control blankets are available through different sources.

3. Other Disclosure of the Invention

The articles, systems and methods of the present invention are further described and/or shown in the attached Appendix material which are hereby incorporated by reference as part of the specification.

4. Conclusion

The terms blanket and patch are used interchangeably above unless specifically noted otherwise.

The descriptions above and the accompanying drawings should be interpreted in the illustrative and not the limited sense. While the invention has been disclosed in connection with an embodiment or embodiments thereof, it should be understood that there may be other embodiments which fall within the scope of the invention as defined by the claims. Where a claim, if any, is expressed as a means or step for performing a specified function it is intended that such claim be construed to cover the corresponding structure, material, or acts described in the specification and equivalents thereof, including both structural equivalents and equivalent structures, material-based equivalents and equivalent materials, and act-based equivalents and equivalent acts.

### Appendix Material

SP 1982-129 Lexington Bridge Erosion

(Temporary and Permanent), Turf, erosion control and Soils Recommendations Part 1 Overview

Temporary Erosion Control Plans

Silt fence: Multiple staging & removal, soil sliced method

Inlet protection

Topsoil berms (keep them seeded)

Rock checks

Temporary seed: 100A Mod., 100A Special

Temporary mulch

Permanent Erosion Control Plans

Inlet/Outlet protection

Seed Mixes

5A Modified (Savanna & Woodland Edge): Northend, east side, plus OES supplied pioneer species tree seed

15A Modified (Mesic Tall grass prairie): Gabion wall, Northend—West side, Interior South end cloverleaf; all areas not seeded otherwise; plus OES supplied pioneer species tree seed

25A Modified (Prairie sedge meadow): Surround all wetland/stormwater ponds and stream edges/disturbed areas, 12 feet wide perimeter

28A Modified (General-purpose native ditch): Wet ditches, temporary overflows and stream edges (disturbance staging)

60A Modified (Low Maintenance Turf): All culvert ends (with Cat 1 blanket 3885), medians, mow areas, and first 6.5 feet adjacent to all shoulders/guard rails (under cat 1 blanket)

100A Modified (Temporary seed mix)—50/50 blend of winter wheat/oats, 100 pounds/ac

100A Special (Temporary seed mix): 75/25 blend of Annual ryegrass/redfescue—100 lbs/ac, Shaded topsoil berms, temp. haul road, shaded areas—

Sod Type B (erosion control sod)—stormwater flumes

Erosion Control Blankets, Cat 1, 3, 4, & 5

Plant Stock

Wetland Mitigation:

Prevegetated Erosion Control Blanket

Wetland plant plugs

2502 Subsurface Drains

S-Bidders are advised that the provisions of Mn/DOT 2502 as contained in the 1995 MN/DOT “Standard Specifications for Construction” shall govern and are modified as follows:

Change D3 to:

D3 Turf Establishment

The Contractor shall use seed and wood fiber blankets at the drain outlets except when outlets are placed at a location that will normally be sodded under terms of the Contract.

A wood fiber blanket (Rapid Degradable Type), meeting 3885, shall be placed to a width of 0.6 m (2 feet) on either side of headwall centerline (or to meet existing turf) and extend 1 m (3 feet) above and 0.5 m (1.5 feet) below headwall. Anchor staples shall be placed at 0.5 m (1.5 feet) maximum intervals. When a headwall is placed at a location that will normally be sodded under terms of the Contract, the seed and mulch shall be deleted in favor of sod. Installations shall be watered and maintained in accordance with 2575.3L. Seed for use with the wood fiber blanket shall be according to 3876, Mixture 50A Modified or seed mix identified in the plan, placed at the rate of 1 kg per square meter (2 pounds per square yard) before fastening the blanket.

3861 Plant Stock

S-Bidders are advised that the provisions of Mn/DOT 3861 as contained in the 1995 Mn/DOT “Standard Specifications for Construction” shall govern and are modified as follows:

3861.2 Requirements, first paragraph, last sentence, shall be changed to read Nursery grown wetland plants will be considered nursery grown as a first year seedling. They will be acceptable when ready for planting as per the Certified Grower.

Origin Requirements: All native wetland grasses and forbs shall be of MN or western Wisconsin origin and of wild ecotype.

TABLE 2571-1
Native Wetland Plant Stock

| Common Name | Taxonomic Name | Qty | Water Depth location |
|---|---|---|---|
| Bottlebrush sedge | Carex comosa | 200 | wet soil to 3 inches |
| Green bulrush | Scirpus atrovirens | 200 | wet soil to 3 inches |
| Woolgrass sedge | Scirpus cyperinus | 200 | Moist soil to 6 inches |
| Soft-stem bulrush | Scirpus validus | 200 | Moist soil to 12 inches |
| Lake sedge | Carex lacustris | 100 | Waters edge |
| Blue-joint grass | Calamagrostis | 200 | Wet soil |
| | canadensis | | |
| Sweet flag | Acorus americana | 100 | Moist soil to 3 inches |
| Reed manna grass | Glyceria grandis | 400 | Upto waters edge |
| Fowl manna grass | Glyceria striata | 400 | Upto waters edge |
| Blue flag iris | Iris shrevei | 50 | Wetland edge, not in water |
| Giant bur-reed | Sparganium | 200 | Wet soil edge |
| | eurycarpum | | |
| Pickerel Plant | Pontederia | 100 | Wet soil to 3 feet |
| | cordata | | |
| Arrowhead | Sagittaria | 100 | Wet soil to 12 inches |
| | latifolia | | |
| Total | | 2450 | |

The plant plugs shall be place in a water-stratified design in 5 to 10 planting clusters around the wetland, according to plant seedling requirements. Each specie listed above shall be planted in groups of 5. If no standing water is present, the plants shall be placed in the wettest portions of the wetland, based on past rain history and soil staining. The Contractor shall be responsible for maintaining the plant plugs for the first 30 days after planting.

Certified Wetland Native Growers are as follows:

Hild & Associates, River Falls, Wis.

Prairie Restorations Inc. Princeton, Minn.

Shooting Star Native Seeds, Spring Grove, Minn.

Ion Exchange, Harpers Ferry, Iowa.

Prairie Moon Nursery, Winona, Minn.

2571.507 Perennial—First year seedling in a minimum of 8 cubic inch soil plug Unit per plant

2575 Turf Establishment

S-Bidders are advised that the provisions of Mn/DOT 2575 as contained in the 1995 MN/DOT “Standard Specifications for Construction” shall govern and are modified as follows:

Add O, Prevegetated Erosion Control Blankets, 3897

2575.2 MATERIALS

| | | |
|---|---|---|
| A | Seed, mix as specified | 3876 |
| B | Blank | |
| C | Sod | 3878 |
| D | Lime | 3879 |
| E | Fertilizer | 3881 |
| F | Mulch, type as specified | 3882 |
| G | Erosion Control Netting | 3883 |
| H | Erosion Control Blanket | 3885 |
| I | Blank | |
| J | Compost | 3890 |
| K | Blank | |
| L | Erosion Stabilization Mat | 3888 |
| O | Prevegetated Erosion Control Blankets | 3897 |

2575.3CONSTRUCTION REQUIREMENTS

O Prevegetated Erosion Control Blankets

Before Prevegetated Erosion Control Blanket is delivered to the work site, the Contractor shall have all necessary equipment and forces available and shall have prepared the Prevegetated Erosion Control Blanketing areas sufficiently in advance in accordance with 2575.3B to avoid delays in placing the product. The Contractor shall place Prevegetated Erosion Control Blankets according to the Plan and these requirements.

The Contractor shall place Prevegetated Erosion Control Blanket strips with staggered end joints and without stretching, in such a manner that all edges will firmly abut the edges of adjoining strips. In no case shall the Prevegetated Erosion Control Blankets be placed so loosely or under such tension that it will cover an area larger than the area from which it was originally produced.

Joints between the Prevegetated Erosion Control Blankets and in-place improvements such as inlet and outlet structures, riprap, cable concrete and existing turf, shall abut tightly and shall be such that drainage will be conducted over the surface. Elsewhere, the outside edges of the Prevegetated Erosion Control Blanketed areas shall be rolled in or banked flush with soil, thoroughly compacted to form a flush surface as directed by the Engineer. The Contractor shall place the Prevegetated Erosion Control Blankets in such a manner that surface drainage along the boundary of the finished area will not erode or undermine the Prevegetated Erosion Control Blanket.

01 Protected Overflow slopes

The Contractor shall carefully place Prevegetated Erosion Control Blanket strips from the bottom of the slope and progress upward. The Prevegetated Erosion Control Blanket shall be placed with the longitudinal axis of each strip at right angles to the slope. Staking or stapling will be required to prevent slumping or displacement of the Prevegetated Erosion Control Blanket. At the top and bottom of the overflow slope, the Prevegetated Erosion Control Blanket must be trenched 75 mm (3 inches) into the topsoil.

02 Ditch Bottoms

In ditch bottoms and other waterways where a concentrated flow of water is expected, the Prevegetated Erosion Control Blanket shall be placed so that the longitudinal axis of each strip is parallel to the direction of water flow in the main channel. The end of the strips will overlap a minimum of 100 mm (4 inches) with the upstream end on top of the downstream end. The Prevegetated Erosion Control Blanket will also be shingled and overlap a minimum of 75 mm (3 inches) on the sides of the strips. When shingled properly, the water will flow over, NOT under, from one roll of Prevegetated Erosion Control Blanket to the next. The uppermost strip of Prevegetated Erosion Control Blanket will have 75 mm (3 inches) of Prevegetated Erosion Control Blanket trenched into the topsoil.

03 Ditch Blocks

In ditch block applications where a concentrated flow of water is assumed, the Prevegetated Erosion Control Blanket shall be placed so that the longitudinal axis of each strip is perpendicular to the direction of water flow in the main channel. The uppermost longitudinal edge of the Prevegetated Erosion Control Blanket will have 75 mm (3 inches) of product trenched into the topsoil. The end of the strips will overlap a minimum of 100 mm (4 inches). When finished, the ditch check blanket will be a minimum of 4 feet wide parallel to the flowing water and a ditch minimum length such that the upper ends are at least 1 foot higher than the normal expected water flow height. The Prevegetated Erosion Control Blanket will also be shingled and overlap a minimum of 75 mm (3 inches) on the sides of the strips. When shingled properly, the water will flow over, NOT under, from one roll of Prevegetated Erosion Control Blanket to the next.

The Prevegetated Erosion Control Blanket shall be stapled once it has been put in place with a minimum 8 inch staple. All joints and outer edges of the Prevegetated Erosion Control Blanket shall be stapled at 0.9 meter (1 foot) intervals or less. Staples shall be placed throughout the Prevegetated Erosion Control Blanket at a minimum spacing of 4 staples per square meter (square yard). All staples shall be inserted flush with the ground surface.

The Contractor shall water and lightly step the Prevegetated Erosion Control Blanket into the soil immediately after completing the Prevegetated Erosion Control Blanket placement on each area. The initial watering and stepping shall be sufficient to provide firm contact and bond between the Prevegetated Erosion Control Blanket and the underlying soil and provide a smooth, even surface free of humps and depressions, but in no case shall the stepping result in excessive compaction or depressions. The Engineer may require the watering of areas to be blanketed prior to the Prevegetated Erosion Control Blanket placement.

The Contractor shall repair damaged areas within 5 working days after completing the Prevegetated Erosion Control Blanket placement and stepping operations. This repair work shall include reseeding and remulching of any seeded or mulched areas adjacent to the Prevegetated Erosion Control Blankets. All stones or other debris removed from the Prevegetated Erosion Control Blanket areas shall be disposed of in a manner satisfactory to the Engineer.

04 Maintenance

After the Prevegetated Erosion Control Blanket is placed and until it is accepted, the Contractor shall water and maintain Prevegetated Erosion Control Blanket in a condition satisfactory to the Engineer. The Prevegetated Erosion Control Blanket shall be cared for on a timely day by day basis. Watering and replacement of Prevegetated Erosion Control Blanket shall be accomplished as the need arises and without the Engineer having to so order.

The Contractor shall maintain the Prevegetated Erosion Control Blanket for 30 growing days. The Engineer will then make the final inspection and consider acceptance of the Prevegetated Erosion Control Blanket. A growing day is any calendar day exclusive of those days from June 10 to August 10 and from November 1 to April 15, subject to adjustments by the Contract. The above specified dates may be adjusted by the Engineer by no more than 15 days, to shorten the excluded periods when conditions are favorable to active growth, or lengthen the excluded periods when conditions are unfavorable.

During the maintenance period, the Contractor shall promptly replace all Prevegetated Erosion Control Blanket that dries out to the point where it is presumed dead, and all Prevegetated Erosion Control Blanket that has been damaged, displaced, or weakened to the point where its replacement is necessary, or has become heavily infected with weeds. Areas replaced with new Prevegetated Erosion Control Blanket shall be maintained by the Contractor for at least 20 growing days after placement.

2575.526 Prevegetated Erosion Control Blanket, Type______square meter (square yard)

3897 Prevegetated Erosion Control Blanket

3897.1SCOPE

This Specification covers semi- or permanent, long lived prevegetated mats to provide anti-animal plant predation, soil reinforcement in ditch bottoms, waterways, wetlands, shorelines and over flow structures where shear stresses are high or highly erodible soils that have frequent runoff or ice. Various classes with different applications, varying in severity of shear stresses are as follows:

TABLE 3879

| PECM | | | |
|---|---|---|---|
| Class | Description | Expected Shear | Application |
| Type 1 | Discrete: 1.5 ft 2 area, | 0 | Wetland Restoration |
| | Cat 5 Blanket (3885) | | |
| Type 2 | Blank | | |
| Type 3 | Short Linear - | 0-170 Pascal | Wetland, stream, or |
| | Perpendicular to water | (3.5 lbs/ft 2) | lak edges, ditch blocks |
| | flow: Cat 5 Blanket, | | |
| | biodegradable netting | | |
| Type 4 | Blank | | |
| Type 5 | Long Linear - Parallel | 170-287 | Channels, ditch blacks |
| | or perpendicular water | Pascal's | |
| | flow: Erosion | (6 lbs/ft 2) | |
| | Stabilization Mat | | |
| | (3888) | | |

3897.2 REQUIREMENTS

A General

Prevegetated Erosion Control Blanket is a commercial product made of 3 materials: a biodegradable coconut blanket or a three dimensional matrix of synthetic material that may also consist partially of biodegradable materials; a soil layer consisting of a weed-free soilless mixture used in commercial greenhouse production facilities, but without floatable components like perlite; and Certified yellow tag seedlings from seed mixtures of 25A Modified or as indicated in the Plan. The Prevegetated Erosion Control Blanket shall be a diverse cross rooted assemblage of clump grasses and forbs with at least 50 percent cover with a minimum of 3 inches in cover crop plant height. The Producer of the material and all components must be Certified by the Office of Environmental Services.

B Materials and Dimensions

Material and dimension requirements will be as indicated in the Plans.

C Staples, Pins

The staples used to anchor the Prevegetated Erosion Control Blanket except Type 1 shall be metal U-shaped, 11 gauge, 20 cm (8 inches) in length. Metal Pins should be at least 4.7 mm (3/16 inch) diameter steel with a 38 mm (1.5 inch) steel washer at the head of the pin, 20 cm(8 inches) in length. Type 1 PECB will only require staples if specified in the Plan.

3897.3 APPROVED MATERIALS 3885,3888,3891

3897.4 SAMPLING AND TESTING 3886.3

Certified Prevegetated Erosion Control Blanket Grower/Producer(s) are as follows:

Hild & Associates, River Falls, Wis.

Mixture 28A Modified (28B)

Index | Home
Mixture 28A Modified (28B) - General Purpose Native Ditch

| Common Name | Botanical Name | % of Mix |
|---|---|---|
| Bluestem, big | Andropogon gerardi | 6.0 |
| Milkweed, marsh | Asclepias incamata | 0.17 |
| Brome, fringed | Bromus ciliate | 4.0 |
| Prairie clover, purple | Dalea purpureum | 0.17 |
| Tic-trefoil, showy | Desmodium canadenee | 0.17 |
| Wheatgrass, slender | Elymus trachycaulus | 10.0 |
| Wild-rye, Virginia | Elymus virginicus | 10.0 |
| Sunflower, early | Heliopsis helianthoides | 0.17 |
| Rye-grass, annual | Lolium italicum | 8.0 |
| ReGreen | NA | 40.0 |
| Switchgrass | Panicum virgatum | 3.0 |
| Bluegrass, fowl | Poa palustris | 12.0 |
| Black-eyed Susan | Rudbeckia hirta | 0.15 |
| Indian grass | Sorghastrum nutans | 6.0 |
| Vervain, blue | Verbena hastata | 0.17 |
| Total: | | 100.00 |

Rate: 40 lbs/acre (44 kg/ha).
Description: Mesic/wet native grass ditch mix. Reaches a height of approximately 36 inches. General purpose mix for use in roadisde ditches that range from wet to dry.

Mixture 25A Modified (26B)

Index | Home
Mixture 25A Modified (26B) - Prairie Meadow & Streambanks

| Common Name | Botanical Name | % of Mix |
|---|---|---|
| Bluestem, big | Andropogon gerardi | 5.0 |
| Canada anemone | Anemone canadensis | 0.1 |
| Marsh milkweed | Asclepias incarnata | 0.5 |
| New England aster | Aster novae-angliae | 0.6 |
| Swamp aster | Aster puniceus | 0.6 |
| Brome, fringed | Bromus ciliata | 8.0 |
| Bluejoint grass | Calamagrostis canadenais | 0.2 |
| Showy tic-trefoil | Desmodium canadense | 0.4 |
| Wheat grass, slender | Elymus trachycaulus | 8.0 |
| Wild rye, Virginia | Elymus virginicus | 6.0 |
| Joe-pye weed | Eupatorium maculatum | 0.4 |
| Boneset | Eupatorium perfoliatum | 0.3 |
| Manna grass, reed | Glyceria grandis | 0.2 |
| Manna grass, fowl | Glyceria striate | 0.3 |
| Early sunflower | Heliopsis helianthoides | 0.7 |
| Blue-flag iris | Iris virginica-shrevii | 0.5 |
| Meadow blazingstar | Liatris ligulistylis | 0.4 |
| Tall blazingstar | Liatris pycnostachya | 0.4 |
| Great blue lobelia | Lobelia siphilitica | 0.1 |
| Rye grass, annual | Lolium italicum | 10.0 |
| Monkey flower | Mimulus ringens | 0.1 |
| Wild Bergamot | Monarda fistulosa | 0.6 |
| ReGreen | NA | 35.0 |
| Switch grass | Panicum virgatum | 1.0 |
| Bluegrass, fowl | Poa palustris | 10.0 |
| Black-eyed Susan's | Rudbeckia hirta | 0.6 |
| Green bulrush | Scirpus atrovirens | 0.3 |
| Wool grass | Scirpus cyperinus | 0.3 |
| Grass-leaved goldenrod | Solidago graminifolia | 0.2 |
| Indian grass | Sorghastrum nutans | 5.0 |
| Cordgrass, prairie | Spartina pectinata | 3.0 |
| Blue vervain | Verbena hastata | 0.5 |
| Ironweed | Veronia fasciculata | 0.2 |
| Culver's root | Veronicastrum virginianum | 0.1 |
| Golden Alexander's | Zizea aurea | 0.4 |
| Total: | | 100.0 |

| | |
|---|---|
| Rate: | 30 lbs/acre (33 kg/ha). |
| Description: | Native sedge/prairie meadow mix. |
| | Reaches a height of 36 to 48 inches. |
| | Developed for use on hydric soils and |
| | for wetland restoration. |
| Installation Note: | Sedges, meadow grasses, and meadow forbs |
| | are best installed by broadcast method, |
| | separate from main grass mix, in early spring |
| | or fall if possible. Also note many of theses species |
| | require pre-germination treatments. |

SP-40.8 Prevegetated Erosion Control Blanket is a commercial product made of 3 materials:, a biodegradable coconut blanket or a three dimensional matrix of synthetic material that may also consist partially of biodegradable materials; a soil layer consisting of a weed-free soilless mixture used in commercial greenhouse production facilities, but without floatable components like perlite; and Certified yellow tag seedlings from seed mixtures of 25 A Modified 28A Modified, or as indicated in the Plan. The Prevegetated Erosion Control Blanket shall he a diverse cross rooted assemblage of clump grasses and/or forbs. All PECM classes except Type 1 shall have least 50 percent cover with a minimum of 3 inches in cover crop plant height. The Producer of the material and all components must be approved by the Engineer.

SP-40.9 Material and dimension requirements will be as indicated in the Plans. The class type used will be Type 3-Cat 5 Blanket, biodegradable netting with 28A Modified seed mix. The following nursery is a pre-approved supplier of the Prevegetated Erosion Control Blanket, other blankets shall be preapproved by the Engineer. Hild and Associates (715) 426-5131.

SP40.10 The staples used to anchor the Prevegetated Erosion Control Blanket will be metal U-shaped, 11 gauge, 8 inches in length.

Eco-Patch Uses—Eco-Patch discs can be used to establish species in standing water where establishment from plugs does not work well. Examples may include areas where wave action may uproot plugs or geese may pull them out. Eco-Patch prevegetated mats are used for shoreline applications or on slopes. Eco-Patch products are attached using biodegradable staples. The discs may be anchored using a medium sized rock. Because the plants are rooted firmly into the coconut fiber mat they are difficult to dislodge.

Eco-Patch Types

Emergent Aquatic—deeper water species that tend to form monoculture or low diversity stands.

Shallow Aquatic—shallower water species that will often form more mixed stands.

Shoreline—very shallow water to hydric soil species that form diverse stands.

| | Primary Species | Secondary Species | Matrix Species |
|---|---|---|---|
| Emergent | Hard-stem bulrush | Soft-stem bulrush | Rattlesnake grass |
| Aquatic | Pickerel weed | Soft-stem bulrush | Rattlesnake grass |
| (6-12″ | Arrowhead | Soft-stem bulrush | Rattlesnake grass |
| water | Bur-reed | Soft-stem bulrush | Rattlesnake grass |
| depth) | Lake sedge | Soft-stem bulrush | Rattlesnake grass |
| Shallow | Soft-stem bulrush | Tussock sedge | Fowl manna grass |
| Aquatic | Tussock sedge | Manna grass | Fowl manna grass |
| (<6″ | Water plantain | Blue-joint grass | Fowl manna grass |
| water | Marsh milkweed | Blue-joint grass | Fowl manna grass |
| depth) | Boneset | Blue-joint grass | Fowl manna grass |
| | Joe-pye weed | Blue-joint grass | Fowl manna grass |
| Shoreline | Blue-flag iris | Fringed brome | Forb species |
| | Great bulrush | Fringed brome | Forb species |

*Primary species established from seedling plugs
**Secondary and Matrix species established from seed

The invention claimed is:

1. An erosion control article comprising a layer of sand, a layer of polyethylene, a article layer, a soil-less mixture layer, and a seed mixture.

2. The article of claim 1, wherein the components are disposed in a article of a predetermined configuration.

3. The article of claim 2, wherein it is a blanket having a relatively large area.

4. The article of claim 2, wherein it is a patch having a relatively small area.

5. The article of claim 2, wherein the configuration is rolled.

6. The article of claim 2, wherein the configuration is folded.

7. The article of claim 2, wherein the configuration is flat.

8. A method of making an erosion control article comprising the steps of constructing a container, adding a layer of sand inside the container, adding a layer of polyethylene over the sand layer, adding a article layer over the polyethylene, adding a layer of soil-less mixture over the article layer, adding a seed mixture to the soil-less mixture, aging the components, and harvesting the aged components.

9. The method of claim 8, wherein the container is a frame.

10. The method of claim 8, wherein the container is a tray.

11. The method of claim 8, wherein the step of aging preferably includes the steps of adding fertilizer, adding a water retention substance, and watering the components.

12. The method of claim 8, further comprising the step of covering the frame with poly film.

13. The method of claim 8, wherein the step of harvesting preferably includes the steps of cutting the aged components into a predetermined configuration, and rolling, folding or laying flat the cut components.
